(19) United States
(12) Patent Application Publication
(10) Pub. No.: US 2026/0039008 A1
(43) Pub. Date: Feb. 5, 2026

(54) FEEDING STRUCTURE AND WINDOW GLASS

(71) Applicant: AGC Inc., Tokyo (JP)

(72) Inventors: Shimpei TOMIDA, Tokyo (JP); Fuminori WATANABE, Tokyo (JP); Kiyoshi NOBUOKA, Tokyo (JP); Hideaki SHOJI, Tokyo (JP)

(73) Assignee: AGC Inc., Tokyo (JP)

(21) Appl. No.: 19/354,811

(22) Filed: Oct. 9, 2025

Related U.S. Application Data
(63) Continuation of application No. PCT/JP2024/014238, filed on Apr. 8, 2024.

(30) Foreign Application Priority Data
Apr. 11, 2023 (JP) 2023-064385

(51) Int. Cl. H01Q 1/12

(52) U.S. Cl. CPC H01Q 1/1285

(57) ABSTRACT

A feeding structure comprises: a dielectric plate for vehicle window having a first surface and a second surface opposite to the first surface; a feeding unit positioned on the first surface side of the dielectric plate; and a receiving unit positioned on the second surface side of the dielectric plate, wherein the dielectric plate includes a first dielectric region between the feeding unit and the receiving unit, and a second dielectric region adjacent to the first dielectric region in a plan view, and the second dielectric region has a relative permittivity lower than that of the first dielectric region when the feeding unit and the receiving unit are electromagnetically coupled to each other.

### INCORPORATION BY REFERENCE

This international application is based upon and claims the benefit of priority from Japanese patent application No. 2023-064385, filed on Apr. 11, 2023, and PCT/JP2024/014238 filed on Apr. 8, 2024, the disclosure of which is incorporated herein in its entirety by reference.

### BACKGROUND

A feeding structure is fed to an antenna structure disposed inside a composite glass plate by a flat conductor has been conventionally known (e.g., see Published Japanese Translation of PCT International Publication for Patent Application, No. 2014-514836).

### SUMMARY

In feeding structures in related art, there are cases where the efficiency of the feeding from the feeding unit to the receiving unit deteriorates.

The present disclosure provides a feeding structure and a window glass capable of preventing the efficiency of the feeding from a feeding unit to a receiving unit from deteriorating.

A feeding structure according to a first aspect comprises:
a dielectric plate for vehicle window having a first surface and a second surface opposite to the first surface;
a feeding unit positioned on the first surface side of the dielectric plate; and
a receiving unit positioned on the second surface side of the dielectric plate, wherein
the dielectric plate includes a first dielectric region between the feeding unit and the receiving unit, and a second dielectric region adjacent to the first dielectric region in a plan view, and
the second dielectric region has a relative permittivity lower than that of the first dielectric region when the feeding unit and the receiving unit are electromagnetically coupled to each other.

A feeding structure according to a second aspect may comprise, in the first aspect, an electromagnetic band gap structure positioned on the first surface side or the second surface side of the dielectric plate, and
the electromagnetic band gap structure may include a part overlapping the second dielectric region in the plan view.

In a feeding structure according to a third aspect, in the second aspect, the electromagnetic band gap structure may be positioned so as to surround the feeding unit or the receiving unit in the plan view.

In a feeding structure according to a fourth aspect, in the third aspect, when a wavelength, in the atmosphere, of an electromagnetic wave input to the feeding unit is represented by λ, the electromagnetic band gap structure may be positioned inside a square region of which a length of each side is 3λ or longer and 5λ or shorter in the plan view.

In a feeding structure according to a fifth aspect, in any one of the second to fourth aspects, when a wavelength, in the atmosphere, of an electromagnetic wave input to the feeding unit is represented by λ, a length of a gap between the electromagnetic band gap structure and the feeding unit or the receiving unit may be 0.1λ or longer and 0.5λ or shorter in the plan view.

In a feeding structure according to a sixth aspect, in any one of the second to fifth aspects, the electromagnetic band gap structure may be positioned on a surface on which the feeding unit or the receiving unit is also disposed.

In a feeding structure according to a seventh aspect, in any one of the second to sixth aspects, the electromagnetic band gap structure may be positioned in an insulating layer in which the feeding unit or the receiving unit is also disposed.

In a feeding structure according to an eighth aspect, in any one of the second to seventh aspects, the electromagnetic band gap structure may have a periodic structure in which a plurality of unit cells are arranged in a periodic manner.

A feeding structure according to a ninth aspect may comprise, in any one of the second to eighth aspects, a first insulating layer positioned on the first surface side of the dielectric plate, and the electromagnetic band gap structure may be formed in the first insulating layer.

In a feeding structure according to a tenth aspect, in the ninth aspect,
the first insulating layer may have a third surface opposed to the first surface and a fourth surface opposite to the third surface, and
the electromagnetic band gap structure may be formed on the third surface or the fourth surface.

In a feeding structure according to an eleventh aspect, in the tenth aspect, the feeding unit may be formed on the third surface or the fourth surface.

In a feeding structure according to a twelfth aspect, in the eleventh aspect, the electromagnetic band gap structure may be formed on a surface on which the feeding unit is also formed.

A feeding structure according to a thirteenth aspect may comprise, in any one of the second to twelfth aspects, a second insulating layer positioned on the second surface side of the dielectric plate, and
the electromagnetic band gap structure may be formed in the second insulating layer.

In a feeding structure according to a fourteenth aspect, in the thirteenth aspect, the second insulating layer may have a fifth surface opposed to
the second surface and a sixth surface opposite to the fifth surface, and
the electromagnetic band gap structure may be formed on the fifth surface or the sixth surface.

In a feeding structure according to a fifteenth aspect, in the fourteenth aspect, the receiving unit may be formed on the fifth surface or the sixth surface.

In a feeding structure according to a sixteenth aspect, in the fifteenth aspect, the electromagnetic band gap structure may be formed on a surface on which the receiving unit is also formed.

In a feeding structure according to a seventeenth aspect, in the first aspect, the second dielectric region may be formed of a material having a relative permittivity different from that of the first dielectric region.

In a feeding structure according to an eighteenth aspect, in the first aspect, the second dielectric region may include a plurality of through-holes formed in the dielectric plate in a thickness direction of the dielectric plate.

A window glass according to a nineteenth aspect comprises a feeding structure according to any one of the first to eighteenth aspects.

A window glass according to a twentieth aspect may comprise, in the nineteenth aspect, a second dielectric plate opposed to the dielectric plate, and
the receiving unit may be located between the dielectric plate and the second dielectric plate.

According to the present disclosure, it is possible to provide a feeding structure and a window glass capable of preventing the efficiency of the feeding from a feeding unit to a receiving unit from deteriorating.

The above and other objects, features and advantages of the present disclosure will become more fully understood from the detailed description given hereinbelow and the accompanying drawings.

### BRIEF DESCRIPTION OF DRAWINGS

FIG. 1 is a partial plan view showing an example of a structure of a window glass including a feeding structure according to a first embodiment;

FIG. 2 is a partial cross-sectional view showing the example of the structure of the window glass including the feeding structure according to the first embodiment;

FIG. 3 is a partial cross-sectional view showing an example of a structure of a window glass including a feeding structure according to a second embodiment;

FIG. 4 is a partial cross-sectional view showing an example of a structure of a window glass including a feeding structure according to a third embodiment;

FIG. 5 is a partial cross-sectional view showing an example of a structure of a window glass including a feeding structure according to a fourth embodiment;

FIG. 6 is a partial cross-sectional view showing an example of a structure of a window glass including a feeding structure according to a fifth embodiment;

FIG. 7 is a partial cross-sectional view showing an example of a structure of a window glass including a feeding structure according to a sixth embodiment;

FIG. 8 is a partial cross-sectional view showing an example of a structure of a window glass including a feeding structure according to a seventh embodiment;

FIG. 9 is a plan view showing a first example of a unit cell included in an electromagnetic band gap structure;

FIG. 10 is a plan view showing a second example of a unit cell included in an electromagnetic band gap structure;

FIG. 11 is a partial plan view showing an example of a structure of a window glass including a feeding structure according to an eighth embodiment;

FIG. 12 is a partial cross-sectional view showing the example of the structure of the window glass including the feeding structure according to the eighth embodiment;

FIG. 13 is a partial plan view showing an example of a structure of a window glass including a feeding structure according to a ninth embodiment; and

FIG. 14 is a partial cross-sectional view showing the example of the structure of the window glass including the feeding structure according to the ninth embodiment.

### DESCRIPTION OF EMBODIMENTS

Embodiments will be described hereinafter with reference to the drawings. Note that for ease of understanding, the scale of each part in the drawings may differ from the actual scale. Regarding the directions such as parallel, right angle, orthogonal, horizontal, vertical, up/down, and left/right, deviations to such a degree that the function and effect of embodiments are not impaired are allowed. The X-axis direction, the Y-axis direction, and the Z-axis direction represent a direction parallel to the X-axis, a direction parallel to the Y-axis, and a direction parallel to the Z-axis, respectively. The X-axis direction, the Y-axis direction, and the Z-axis direction are orthogonal to each other. The XY-plane, the YZ-plane, and the ZX-plane represent an imaginary plane parallel to the X- and Y-axis directions, an imaginary plane parallel to the Y- and Z-axis directions, and an imaginary plane parallel to the Z- and X-axis directions, respectively.

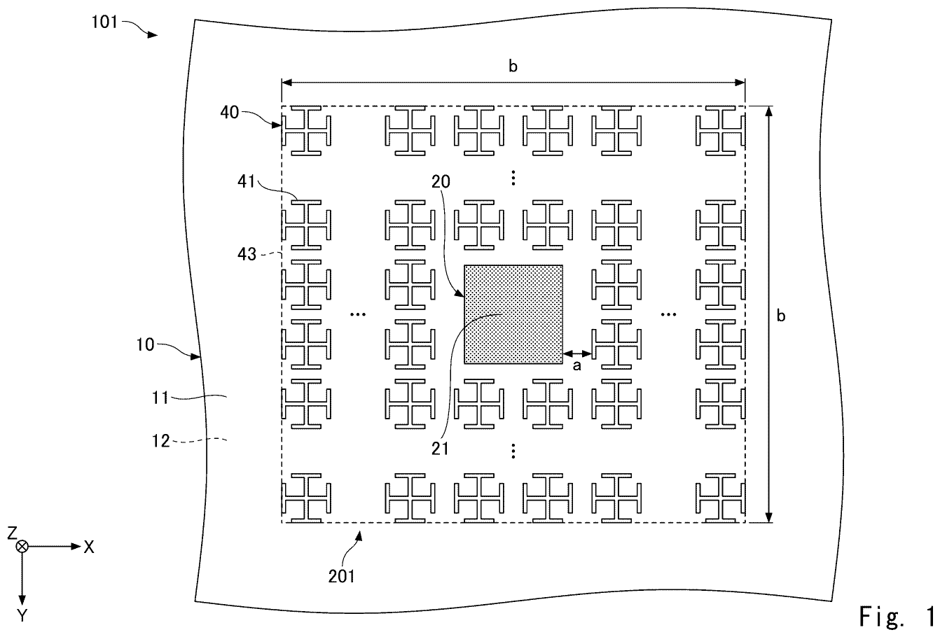

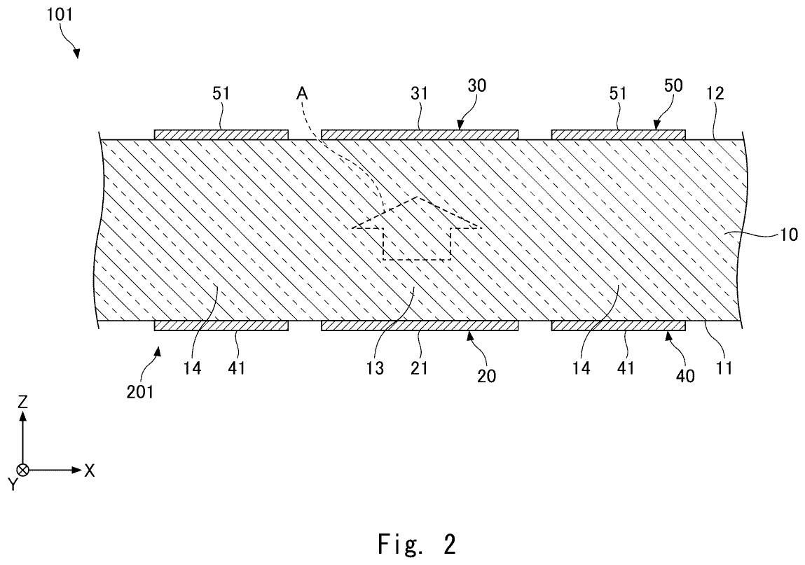

FIG. 1 is a partial plan view showing an example of a structure of a window glass including a feeding structure according to a first embodiment. FIG. 1 is a plan view of a window glass 101 (or a dielectric plate 10 included in the window glass 101). FIG. 2 is a partial cross-sectional view showing the example of the structure of the window glass including the feeding structure according to the first embodiment. The window glass 101 shown in FIGS. 1 and 2 is a plate-like article including a feeding structure 201 that feeds from a feeding unit 20 to a receiving unit 30 in a non-contact manner through electromagnetic coupling therebetween.

The window glass 101 is a window glass for vehicle. Examples of window glasses for vehicle include a wind shield attached to a front part of a vehicle, a rear glass attached to a rear part of a vehicle, a side glass attached to a side part of a vehicle, and a roof glass attached to a ceiling part of a vehicle. Window glasses for vehicle are not limited to these examples.

The feeding structure 201 includes a dielectric plate 10 parallel to the XY-plane, a feeding unit 20 positioned on the negative side of the dielectric plate 10 in the Z-axis direction, and a receiving unit 30 positioned on the positive side of the dielectric plate 10 in the Z-axis direction.

The dielectric plate 10 is a member for vehicle window and is optically transparent. The dielectric plate 10 is a plate-like member mainly made of a dielectric and is, for example, a glass plate. The dielectric plate 10 may be a plate other than the glass plate (e.g., a resin plate).

The dielectric plate 10 is a plate-like dielectric having a main surface 11 facing in the Z-axis negative direction and another main surface 12 facing in the direction opposite to the main surface 11 (i.e., facing in the Z-axis positive direction). Although the main surfaces 11 and 12 are shown parallel to the XY-plane in the drawing, the main surface 11 or 12 may be curved with respect to the XY-plane. In the case where the main surface 11 or 12 is curved with respect to the XY-plane, that is, the dielectric plate 10 has a curved shape, the dielectric plate 10 may have a single curved shape, i.e., curved in either the lateral direction or the vertical direction, or may have a double curved shape, i.e., curved in both the lateral direction and the vertical direction. In the case where the dielectric plate 10 has a curved shape, the radius of the curvature may be 2,000 to 11,000 mm. In the case where the dielectric plate 10 is a glass plate, gravity bending, press bending, roller bending, or the like is used for the bending of the dielectric plate 10.

In the case where the window glass 101 is a window glass for vehicle, the main surface 11 is a surface of the window glass 101 located inside the vehicle, and the main surface 12 is a surface of the window glass 101 located outside the vehicle. However, the main surface 11 may be a surface of the window glass 101 located outside the vehicle, and the main surface 12 may be a surface of the window glass 101 located inside the vehicle. The main surface 11 is an example of the first surface. The main surface 12 is an example of the second surface opposite to the first surface.

The feeding unit 20 is positioned on the main surface 11 side of the dielectric plate 10. The feeding unit 20 is a part to which one end of a feeding member (not shown) (e.g., a transmission line such as a coaxial cable) to be attached to the window glass 101 is electrically connected. The feeding unit 20 includes, for example, a feeding electrode 21 disposed on the main surface 11 side of the dielectric plate 10. In the example shown in FIG. 2, the feeding electrode 21 is a flat feeding pattern formed by a conductor on the main surface 11. The shape of the feeding electrode 21 in a plan view is not limited to the rectangular shape, and may be other shapes (such as a polygon other than the rectangle or a circle).

The receiving unit 30 is positioned on the main surface 12 side of the dielectric plate 10. The receiving unit 30 is a part to which one end of a receiving member (not shown) (such as an antenna element or a signal line) disposed on the window glass 101 is electrically connected. The receiving unit 30 includes, for example, a receiving electrode 31 disposed on the main surface 12 side of the dielectric plate 10. In the example shown in FIG. 2, the receiving electrode 31 is a flat receiving pattern formed by a conductor on the main surface 12. The shape of the receiving electrode 31 in the plan view is not limited to the rectangular shape, and may be other shapes (such as a polygon other than the rectangle or a circle).

The dielectric plate 10 includes a dielectric region 13 between the feeding unit 20 and the receiving unit 30, and a dielectric region 14 adjacent to the dielectric region 13 in the plan view. The dielectric region 13 is, for example, a region interposed between the feeding electrode 21 and the receiving electrode 31 in the plate-thickness direction of the dielectric plate 10 (i.e., in the Z-axis direction). The dielectric region 14 is, for example, a region that is not interposed between the feeding electrode 21 and the receiving electrode 31 in the plate-thickness direction of the dielectric plate 10 (i.e., in the Z-axis direction). The dielectric region 13 functions as a waveguide for an electromagnetic wave A that propagates from the feeding unit 20 to the receiving unit 30 through electromagnetic coupling therebetween. The dielectric region 13 is an example of the first dielectric region. The dielectric region 14 is an example of the second dielectric region adjacent to the first dielectric region in the plan view.

The feeding structure 201 includes an electromagnetic band gap structure 40 positioned on the main surface 11 side of the dielectric plate 10 and an electromagnetic band gap structure 50 positioned on the main surface 12 side of the dielectric plate 10. The feeding structure 201 may include only one of the electromagnetic band gap structures 40 and 50.

The electromagnetic band gap structure is one of metamaterials that have a characteristic for suppressing the propagation of electromagnetic waves in a specific frequency band. In a region where either the relative permittivity or the magnetic permeability is negative, there is no propagation solution, so that the propagation of electromagnetic waves is prohibited. The band in which the propagation of electromagnetic waves is prohibited or suppressed is called an electromagnetic band gap (EBG), and a structure realizing an EBG is called an “EBG structure”. The electromagnetic band gap structure (EBG structure) has a periodic structure in which one or a plurality of unit cells formed of a conductor or the like are arranged in a periodic manner.

As shown in FIGS. 1 and 2, the electromagnetic band gap structure 40 has a periodic structure in which a plurality of unit cells 41 formed of a conductor or the like are arranged in a periodic manner. Similarly, the electromagnetic band gap structure 50 has a periodic structure in which a plurality of unit cells 51 formed of a conductor or the like are arranged in a periodic manner. FIG. 1 shows an example of a shape of a conductor pattern of unit cells 41. The unit cell 51 has the same shape as the conductor pattern of the unit cell 41, but may have a different shape.

In FIG. 2, the electromagnetic band gap structure 40 has a part (e.g., one or a plurality of unit cells 41) which overlaps the dielectric region 14 in the plan view, but does not have any part which overlaps the dielectric region 13 in the plan view. Since the electromagnetic band gap structure 40 has the part overlapping the dielectric region 14 in the plan view, the dielectric region 14 has a relative permittivity lower than that of the dielectric region 13 when the feeding unit 20 and the receiving unit 30 are electromagnetically coupled to each other. As the relative permittivity of the dielectric region 13 is relatively higher than that of the dielectric region 14, the leakage of an electromagnetic wave A from the dielectric region 13 to the dielectric region 14 is suppressed, so that the leakage of the electromagnetic wave A from the dielectric region 13 to the main surface 11 or 12 is suppressed. Therefore, since the loss of the electromagnetic wave A propagating from the feeding unit 20 to the receiving unit 30 through the dielectric region 13 is reduced, an effect of preventing the efficiency of the feeding from the feeding unit 20 to the receiving unit 30 from deteriorating is obtained.

Similarly, the electromagnetic band gap structure 50 has a part (e.g., one or a plurality of unit cells 51) which overlaps the dielectric region 14 in the plan view, but does not have any part which overlaps the dielectric region 13 in the plan view. Since the electromagnetic band gap structure 50 has the part overlapping the dielectric region 14 in the plan view, the dielectric region 14 has a relative permittivity lower than that of the dielectric region 13 when the feeding unit 20 and the receiving unit 30 are electromagnetically coupled to each other. Therefore, for the same reason as described above, an effect of preventing the efficiency of the feeding from the feeding unit 20 to the receiving unit 30 from deteriorating is obtained.

As shown in FIG. 1, the electromagnetic band gap structure 40 may be positioned so as to surround the feeding unit 20 in the plan view. For example, a plurality of unit cells 41 are arranged so as to surround the feeding electrode 21 in the plan view. By positioning the electromagnetic band gap structure 40 so as to surround the feeding unit 20 in the plan view, the relative permittivity of the dielectric region 14 around the dielectric region 13 becomes lower than that of the dielectric region 13 over the entire periphery when the feeding unit 20 and the receiving unit 30 are electromagnetically coupled to each other. Therefore, the leakage of the electromagnetic wave A from the dielectric region 13 to the dielectric region 14 is suppressed over the entire periphery, so that the effect of preventing the efficiency of the feeding from the feeding unit 20 to the receiving unit 30 from deteriorating is enhanced.

Similarly, the electromagnetic band gap structure 50 may be positioned so as to surround the receiving unit 30 in the plan view. For example, a plurality of unit cells 51 are arranged so as to surround the receiving electrode 31 in the plan view. By positioning the electromagnetic band gap structure 50 so as to surround the receiving unit 30 in the plan view, the relative permittivity of the dielectric region 14 around the dielectric region 13 becomes lower than that of the dielectric region 13 over the entire periphery when the feeding unit 20 and the receiving unit 30 are electromagnetically coupled to each other. Therefore, the leakage of the electromagnetic wave A from the dielectric region 13 to the dielectric region 14 is suppressed over the entire periphery, so that the effect of preventing the efficiency of the supply from the feeding unit 20 to the receiving unit 30 from deteriorating is enhanced.

The frequency band of electromagnetic waves input to the feeding unit 20 is a relatively high band, i.e., a UHF (Ultra High Frequency) band from 300 MHz to 3 GHz, an SHF (Super High Frequency) band from 3 GHz to 30 GHz, or an EHF (Extremely High Frequency) band from 30 GHz to 300 GHz. As specific examples of such high frequency bands, there are bands used in the fifth generation communication (5G) standards (a frequency band of 6 GHz or lower (sub6) and a frequency band of 24 GHz or higher (such as a 28 GHz band and a 39 GHz band).

In FIG. 1, a wavelength, in the atmosphere, of electromagnetic waves input to the feeding unit 20 is represented by λ. Then, the electromagnetic band gap structure 40 may be positioned inside a square region 43 of which the length b of each side is 3λ, or longer and 5λ or shorter in the plan view. In this way, the effect of preventing the efficiency of the supply from the feeding unit 20 to the receiving unit 30 from deteriorating is ensured, and the expansion of the range in which the electromagnetic band gap structure 40 is disposed is prevented. By preventing the expansion of the range in which the electromagnetic band gap structure 40 is disposed, the remaining region other than the electromagnetic band gap structure 40 on the main surface of the window glass 101 is relatively increased. Therefore, other functions such as a function as a display and a function of a camera can be easily allocated in the remaining region other than the electromagnetic band gap structure 40.

Even when the electromagnetic band gap structure 50 is positioned inside the square region 43 of which the length b of each side is 3λ, or longer and 5λ or shorter in the plan view, the same effect as the effect obtained in regard to the electromagnetic band gap structure 40 is obtained.

The length b may be 3.2, or longer and 4.8λ or shorter, or 3.4λ or longer and 4.6λ or shorter in order to prevent the efficiency of the supply from the feeding unit 20 to the receiving unit 30 from deteriorating and to prevent the range in which the electromagnetic band gap structure is disposed from expanding.

In the plan view, the length a of the gap (hereinafter also referred to as the gap length a) between the unit cells 41 of the electromagnetic band gap structure 40 and the feeding electrode 21 of the feeding unit 20 may be 0.1λ or longer and 0.5λ or shorter. In this way, the deterioration of the effect of blocking electromagnetic waves caused by the interference between the unit cells 41 of the electromagnetic band gap structure 40 and the feeding electrode 21 of the feeding unit 20 is prevented, and the leakage of electromagnetic waves from the area between the unit cells 41 of the electromagnetic band gap structure 40 and the feeding electrode 21 of the feeding unit 20 is suppressed.

In the plan view, the length a of the gap between the unit cells 51 of the electromagnetic band gap structure 50 and the receiving electrode 31 of the receiving unit 30 may be 0.1λ or longer and 0.5λ or shorter. In this way, the deterioration of the effect of blocking electromagnetic waves caused by the interference between the unit cells 51 of the electromagnetic band gap structure 50 and the receiving electrode 31 of the receiving unit 30 is prevented, and the leakage of electromagnetic waves from the area between the unit cells 51 of the electromagnetic band gap structure 50 and the receiving electrode 31 of the receiving unit 30 is suppressed.

The gap length a may be 0.15λ or longer and 0.45λ shorter, or 0.2λ or longer and 0.4λ or shorter in order to prevent the deterioration of the effect of blocking electromagnetic waves and to suppress the leakage of electromagnetic waves.

As shown in FIG. 2, the electromagnetic band gap structure 40 may be positioned on the surface on which the feeding unit 20 is also disposed. In the example shown in FIG. 2, the unit cells 41 are positioned on the main surface 11 on which the feeding electrode 21 is also disposed. Since the electromagnetic band gap structure 40 is positioned on the surface on which the feeding unit 20 is also disposed, the feeding electrode 21 and the unit cells 41 can be formed by the same formation method.

As shown in FIG. 2, the electromagnetic band gap structure 50 may be positioned on the surface on which the receiving unit 30 is also disposed. In the example shown in FIG. 2, the unit cells 51 are positioned on the main surface 12 on which the receiving electrode 31 is also disposed. Since the electromagnetic band gap structure 50 is positioned on the surface on which the receiving unit 30 is also disposed, the receiving electrode 31 and the unit cells 51 can be formed by the same formation method.

The method for forming the feeding unit 20 and the electromagnetic band gap structure 40 in the dielectric plate 10 is not limited to any particular methods. The pattern that will serve as the feeding unit 20 and the electromagnetic band gap structure 40 may be formed on the main surface 11 of the dielectric plate 10 by, for example, printing or transferring a conductor. In the case where the dielectric plate 10 is a glass plate, the pattern may be formed by applying a conductive paste containing a powder of a conductor and glass frit to the main surface 11 of the dielectric plate 10 and firing the applied conductive paste. Examples of powders of conductors include silver, copper, tin, gold, aluminum, iron, tungsten, chromium, and alloys containing these conductors. Note that the feeding unit 20 and the electromagnetic band gap structure 40 may be formed on a light shielding layer (not shown) formed on the main surface 11 side of the dielectric plate 10. For example, in the case where the dielectric plate 10 is a glass plate, the light shielding layer may be formed by applying and firing a ceramic paste containing a black pigment and glass frit. Further, the pattern may be formed by printing an organic ink or an inorganic ink on the dielectric plate 10. The organic ink or the inorganic ink can be printed by inkjet printing, screen printing, or the like. The thickness of the light shielding layer is, for example, 5 to 20 μm.

The method for forming the receiving unit 30 and the electromagnetic band gap structure 50 in the dielectric plate 10 is not limited to any particular methods. The pattern that will serve as the receiving unit 30 and the electromagnetic band gap structure 50 may be formed on the main surface 12 of the dielectric plate 10 by, for example, printing or transferring a conductor. In the case where the dielectric plate 10 is a glass plate, the pattern may be formed by applying a conductive paste containing a powder of a conductor and glass frit to the main surface 12 of the dielectric plate 10 and firing the applied conductive paste. Examples of powders of conductors include silver, copper, tin, gold, aluminum, iron, tungsten, chromium, and alloys containing these conductors.

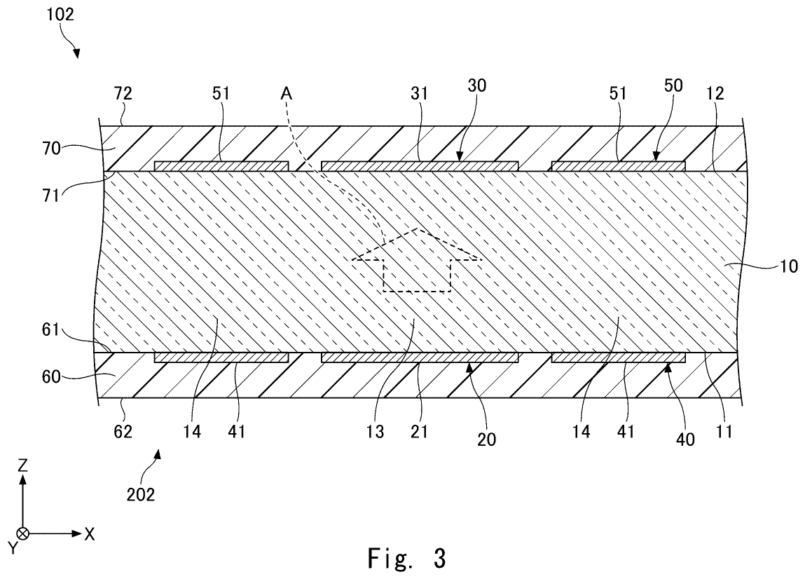

FIG. 3 is a partial cross-sectional view showing an example of a structure of a window glass including a feeding structure according to a second embodiment. In the second embodiment, descriptions of structures, operations, and effects similar to those in the above-described embodiment will be omitted by referring to the descriptions in the above-described embodiment. A window glass 102 shown in FIG. 3 is a plate-like article including a feeding structure 202 that feeds from a feeding unit 20 to a receiving unit 30 in a non-contact manner through electromagnetic coupling therebetween. The feeding structure 202 according to the second embodiment differs from the feeding structure 201 according to the first embodiment (FIG. 2) in that the feeding structure 202 includes an insulating layer 60 and an insulating layer 70.

In FIG. 3, the feeding structure 202 includes the insulating layer 60 positioned on the main surface 11 side of the dielectric plate 10 and the insulating layer 70 positioned on the main surface 12 side of the dielectric plate 10. The feeding structure 202 may include only one of the insulating layers 60 and 70. The insulating layer 60 is an example of the first insulating layer. The insulating layer 70 is an example of the second insulating layer.

The feeding structure 202 according to the second embodiment includes an electromagnetic band gap structure 40 including unit cells 41 which are in contact with the main surface 11, and an electromagnetic band gap structure 50 including unit cells 51 which are in contact with the main surface 12. Each of the electromagnetic band gap structures 40 and 50 in the second embodiment includes a part overlapping the dielectric region 14 in the plan view as in the case of the first embodiment. Therefore, the dielectric region 14 has a relative permittivity lower than that of the dielectric region 13 when the feeding unit 20 and the receiving unit 30 are electromagnetically coupled to each other, so that an effect of preventing the efficiency of the feeding from the feeding unit 20 to the receiving unit 30 from deteriorating can be obtained.

Each of the insulating layers 60 and 70 is, for example, a dielectric layer mainly made of a dielectric. Each of the insulating layers 60 and 70 may be a plate-like or film-like component. Specific examples of the insulating layers 60 and 70 include a flexible substrate and a rigid substrate.

The electromagnetic band gap structure 40 is formed on the insulating layer 60 on which the feeding unit 20 is also formed. In the example shown in FIG. 3, the electromagnetic band gap structure 40 includes unit cells 41 formed on the insulating layer 60 on which the feeding electrode 21 of the feeding unit 20 is also formed. Since the electromagnetic band gap structure 40 is formed on the insulating layer 60 on which the feeding unit 20 is also formed, the electromagnetic band gap structure 40 and the feeding unit 20 can be easily formed.

The insulating layer 60 has a surface 61 opposed to the main surface 11 and a surface 62 facing in the direction opposite to the surface 61. The electromagnetic band gap structure 40 is formed on the surface 61 on which the feeding unit 20 is also formed. In the example shown in FIG. 3, the electromagnetic band gap structure 40 includes unit cells 41 formed on the surface 61 on which the feeding electrode 21 of the feeding unit 20 is also formed. Since the electromagnetic band gap structure 40 is formed on the surface 61 on which the feeding unit 20 is also formed, the electromagnetic band gap structure 40 and the feeding unit 20 can be easily formed. The surface 61 is an example of the third surface. The surface 62 is an example of the fourth surface.

The method for forming at least one of the feeding unit 20 and the electromagnetic band gap structure 40 on at least one of the surfaces 61 and 62 of the insulating layer 60 is not limited to any particular methods. A pattern that will serve as at least one of the feeding unit 20 and the electromagnetic band gap structure 40 may be printed or transferred on at least one of the surfaces 61 and 62 of the insulating layer 60, or a pattern that will serve as at least one of the feeding unit 20 and the electromagnetic band gap structure 40 may be formed by etching or the like after a conductor layer is formed on at least one of the surfaces 61 and 62 of the insulating layer 60. Examples of materials of conductor layers include silver, copper, tin, gold, aluminum, iron, tungsten, chromium, and alloys containing these conductors.

The electromagnetic band gap structure 50 is formed on the insulating layer 70 on which the receiving unit 30 is also formed. In the example shown in FIG. 3, the electromagnetic band gap structure 50 includes unit cells 51 formed on the insulating layer 70 on which the receiving electrode 31 of the receiving unit 30 is also formed. Since the electromagnetic band gap structure 50 is formed on the insulating layer 70 on which the receiving unit 30 is also formed, the electromagnetic band gap structure 50 and the receiving unit 30 can be easily formed.

The insulating layer 70 has a surface 71 opposed to the main surface 12 and a surface 72 facing in the direction opposite to the surface 71. The electromagnetic band gap structure 50 is formed on the surface 71 on which the receiving unit 30 is also formed. In the example shown in FIG. 3, the electromagnetic band gap structure 50 includes unit cells 51 formed on the surface 71 on which the receiving electrode 31 of the receiving unit 30 is also formed. Since the electromagnetic band gap structure 50 is formed on the surface 71 on which the receiving unit 30 is also formed, the electromagnetic band gap structure 50 and the receiving unit 30 can be easily formed. The surface 71 is an example of the fifth surface. The surface 72 is an example of the sixth surface.

The method for forming at least one of the receiving unit 30 and the electromagnetic band gap structure 50 on at least one of the surfaces 71 and 72 of the insulating layer 70 is not limited to any particular methods. A pattern that will serve as at least one of the receiving unit 30 and the electromagnetic band gap structure 50 may be printed and transferred on at least one of the surfaces 71 and 72 of the insulating layer 70, or a pattern that will serve as at least one of the receiving unit 30 and the electromagnetic band gap structure 50 may be formed by etching or the like after a conductor layer is formed on at least one of the surfaces 71 and 72 of the insulating layer 70. Examples of materials of conductor layers include silver, copper, tin, gold, aluminum, iron, tungsten, chromium, and alloys containing these conductors.

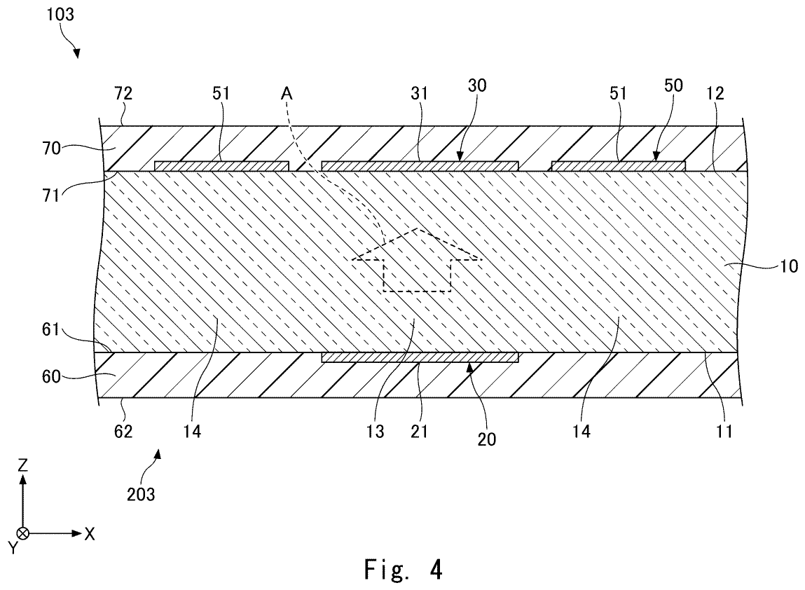

FIG. 4 is a partial cross-sectional view showing an example of a structure of a window glass including a feeding structure according to a third embodiment. In the third embodiment, descriptions of structures, operations, and effects similar to those in the above-described embodiment will be omitted by referring to the descriptions in the above-described embodiment. A window glass 103 shown in FIG. 4 is a plate-like article including a feeding structure 203 that feeds from a feeding unit 20 to a receiving unit 30 in a non-contact manner through electromagnetic coupling therebetween. The feeding structure 203 according to third embodiment differs from the feeding structure 202 according to the second embodiment (FIG. 3) in that the feeding structure 203 does not include the electromagnetic band gap structure 40.

In FIG. 4, the feeding structure 203 according to the third embodiment includes an electromagnetic band gap structure 50 including unit cells 51 which are in contact with the main surface 12. The electromagnetic band gap structure 50 in the third embodiment includes a part overlapping the dielectric region 14 in the plan view as in the case of the second embodiment. As a result, the dielectric region 14 has a relative permittivity lower than that of the dielectric region 13 when the feeding unit 20 and the receiving unit 30 are electromagnetically coupled to each other. Therefore, even though the electromagnetic band gap structure 40 is not provided, an effect of preventing the efficiency of the feeding from the feeding unit 20 to the receiving unit 30 from deteriorating is obtained owing to the provision of the electromagnetic band gap structure 50.

Note that the feeding structure 203 may not include the electromagnetic band gap structure 50, and may include an electromagnetic band gap structure 40 including unit cells 41 which are in contact with the main surface 11. Even though the electromagnetic band gap structure 50 is not provided, an effect of preventing the efficiency of the supply from the feeding unit 20 to the receiving unit 30 from deteriorating is obtained owing to the provision of the electromagnetic band gap structure 40.

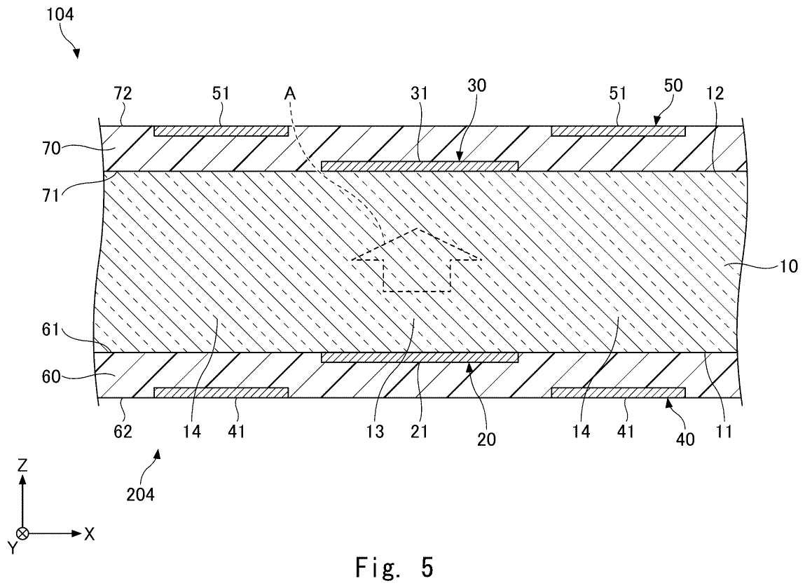

FIG. 5 is a partial cross-sectional view showing an example of a structure of a window glass including a feeding structure according to a fourth embodiment. In the fourth embodiment, descriptions of structures, operations, and effects similar to those in the above-described embodiment will be omitted by referring to the descriptions in the above-described embodiment. A window glass 104 shown in FIG. 5 is a plate-like article including a feeding structure 204 that supplies electric from a feeding unit 20 to a receiving unit 30 in a non-contact manner through electromagnetic coupling therebetween. The feeding structure 204 according to the fourth embodiment differs from the feeding structure 202 according to the second embodiment (FIG. 3) in that the electromagnetic band gap structure 40 is formed on the surface 62 and the electromagnetic band gap structure 50 is formed on the surface 72.

In FIG. 5, the feeding structure 204 according to the fourth embodiment includes an electromagnetic band gap structure 40 including unit cells 41 which are not in contact with the main surface 11, and an electromagnetic band gap structure 50 including unit cells 51 which are not in contact with the main surface 12.

The electromagnetic band gap structure 40 in the fourth embodiment includes unit cells 41 formed on a surface 62 different from the surface on which the feeding electrode 21 of the feeding unit 20 is formed. Note that the feeding electrode 21 of the feeding unit 20 may be formed on the surface 62 on which the unit cells 41 are also formed. The electromagnetic band gap structure 50 includes unit cells 51 formed on a surface 72 different from the surface on which the receiving electrode 31 of the receiving unit 30 is formed. Note that the receiving electrode 31 of the receiving unit 30 may be formed on the surface 72 on which the unit cells 51 are also formed.

The electromagnetic band gap structures 40 and 50 in the fourth embodiment include a part overlapping the dielectric region 14 in the plan view as in the case of the second embodiment. Therefore, the dielectric region 14 has a relative permittivity lower than that of the dielectric region 13 when the feeding unit 20 and the receiving unit 30 are electromagnetically coupled to each other, so that an effect of preventing the efficiency of the feeding from the feeding unit 20 to the receiving unit 30 from deteriorating can be obtained.

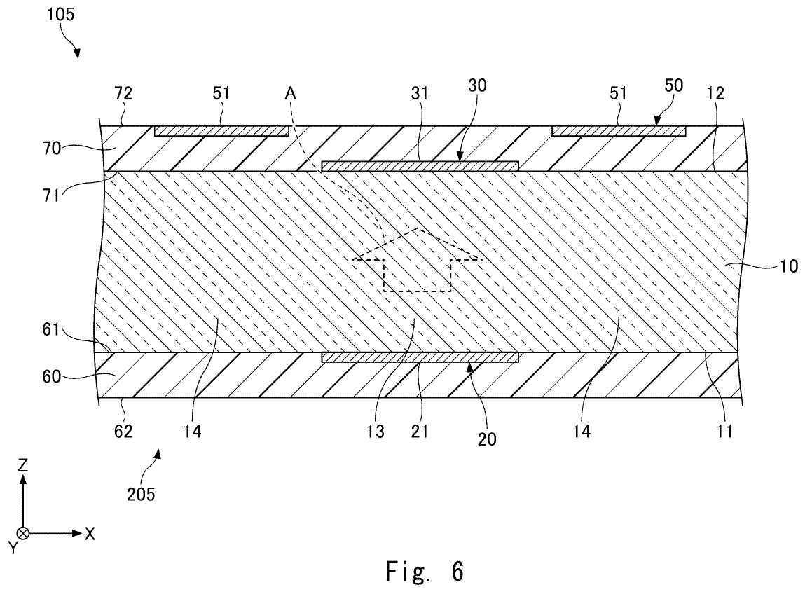

FIG. 6 is a partial cross-sectional view showing an example of a structure of a window glass including a feeding structure according to a fifth embodiment. In the fifth embodiment, descriptions of structures, operations, and effects similar to those in the above-described embodiment will be omitted by referring to the descriptions in the above-described embodiment. A window glass 105 shown in FIG. 6 is a plate-like article including a feeding structure 205 that feeds from a feeding unit 20 to a receiving unit 30 in a non-contact manner through electromagnetic coupling therebetween. The feeding structure 205 according to the fifth embodiment differs from the feeding structure 202 according to the second embodiment (FIG. 3) in that the feeding structure 205 does not include the electromagnetic band gap structure 40.

In FIG. 6, the feeding structure 205 according to the fifth embodiment includes an electromagnetic band gap structure 50 including unit cells 51 which are not in contact with the main surface 12. The electromagnetic band gap structure 50 in the fifth embodiment includes a part overlapping the dielectric region 14 in the plan view as in the case of the second embodiment. As a result, the dielectric region 14 has a relative permittivity lower than that of the dielectric region 13 when the feeding unit 20 and the receiving unit 30 are electromagnetically coupled to each other. Therefore, even though the electromagnetic band gap structure 40 is not provided, an effect of preventing the efficiency of the supply from the feeding unit 20 to the receiving unit 30 from deteriorating is obtained owing to the provision of the electromagnetic band gap structure 50.

Note that the feeding structure 205 may not include the electromagnetic band gap structure 50, and may include an electromagnetic band gap structure 40 including unit cells 41 which are not in contact with the main surface 11. Even though the electromagnetic band gap structure 50 is not provided, an effect of preventing the efficiency of the supply from the feeding unit 20 to the receiving unit 30 from deteriorating is obtained owing to the provision of the electromagnetic band gap structure 40.

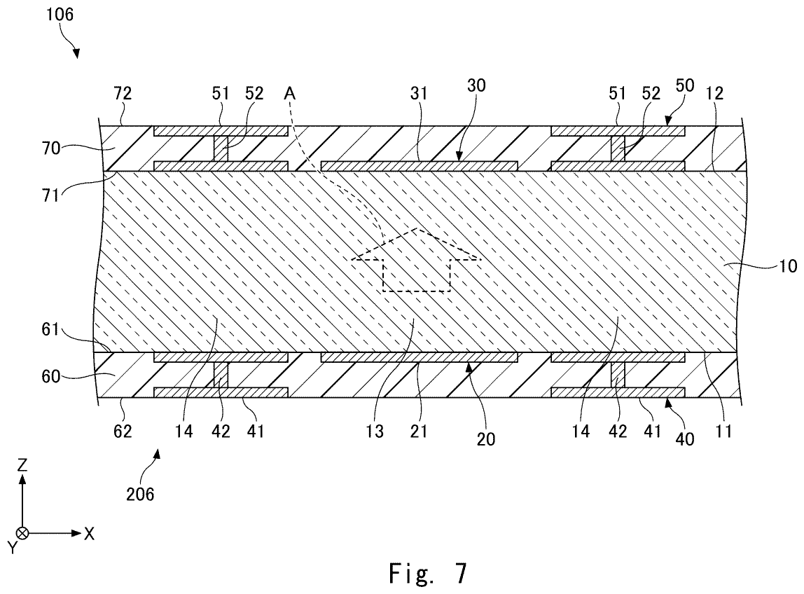

FIG. 7 is a partial cross-sectional view showing an example of a structure of a window glass including a feeding structure according to a sixth embodiment. In the sixth embodiment, descriptions of structures, operations, and effects similar to those in the above-described embodiment will be omitted by referring to the descriptions in the above-described embodiment. A window glass 106 shown in FIG. 7 is a plate-like article including a feeding structure 206 that feeds from a feeding unit 20 to a receiving unit 30 in a non-contact manner through electromagnetic coupling therebetween. The feeding structure 206 according to the sixth embodiment differs from the feeding structure 202 according to the second embodiment (FIG. 3) in that the electromagnetic band gap structures 40 and 50 include through-holes.

In FIG. 7, the electromagnetic band gap structure 40 includes a through-hole(s) 42 for interconnecting a unit cell(s) 41 formed on the surface 61 with a unit cell(s) 41 formed on the surface 62, and the electromagnetic band gap structure 50 includes a through-hole(s) 52 for interconnecting a unit cell(s) 51 formed on the surface 71 with a unit cell(s) 51 formed on the surface 72. Each of the electromagnetic band gap structures 40 and 50 in the sixth embodiment includes a part overlapping the dielectric region 14 in the plan view as in the case of the first embodiment. Therefore, the dielectric region 14 has a relative permittivity lower than that of the dielectric region 13 when the feeding unit 20 and the receiving unit 30 are electromagnetically coupled to each other, so that an effect of preventing the efficiency of the feeding from the feeding unit 20 to the receiving unit 30 from deteriorating can be obtained.

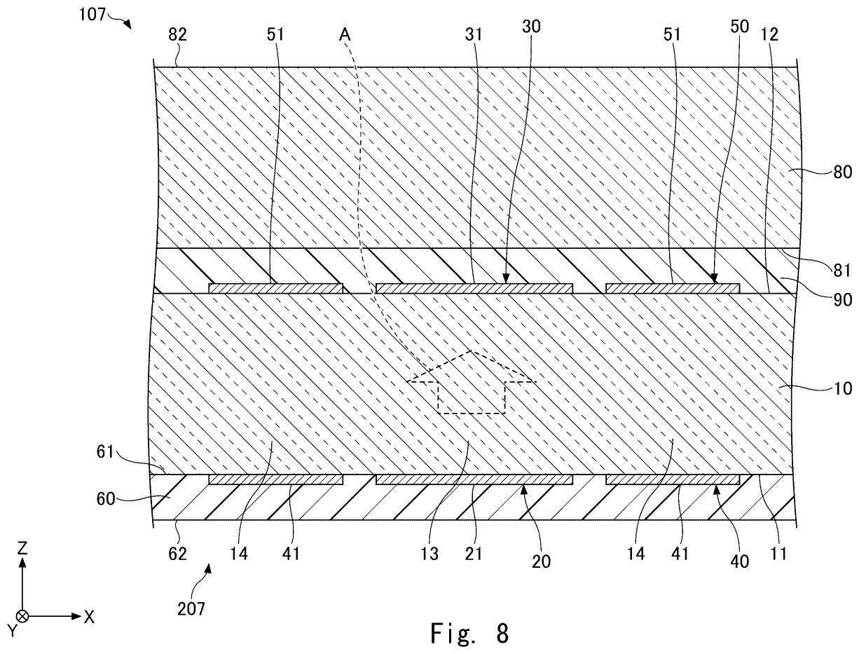

FIG. 8 is a partial cross-sectional view showing an example of a structure of a window glass including a feeding structure according to a seventh embodiment. In the seventh embodiment, descriptions of structures, operations, and effects similar to those in the above-described embodiment will be omitted by referring to the descriptions in the above-described embodiment. A window glass 107 shown in FIG. 8 is a plate-like article including a feeding structure 207 that feeds from a feeding unit 20 to a receiving unit 30 in a non-contact manner through electromagnetic coupling therebetween. The feeding structure 207 according to the seventh embodiment differs from the feeding structures in the above-described embodiments in that feeding is fed to a receiving unit 30 located between a pair of dielectric plates 10 and 80. The window glass 107 is a laminate including the pair of dielectric plates 10 and 80 and an intermediate film 90.

Each of the electromagnetic band gap structures 40 and 50 in the seventh embodiment includes a part overlapping the dielectric region 14 in the plan view as in the case of the above-described embodiments. Therefore, the dielectric region 14 has a relative permittivity lower than that of the dielectric region 13 when the feeding unit 20 and the receiving unit 30 are electromagnetically coupled to each other, so that an effect of preventing the efficiency of the supply from the feeding unit 20 to the receiving unit 30 from deteriorating can be obtained. Note that the feeding structure according to the seventh embodiment may be substituted for any of the feeding structures according to the above-described embodiments.

Each of the pair of dielectric plates 10 and 80 is a plate-like member mainly made of a dielectric. One or each of both of the pair of dielectric plates 10 and 80 may be a glass plate. For example, in the case where the dielectric plate 10 is a glass plate, the dielectric plate 80 may be a dielectric plate different from the glass plate, whereas in the case where the dielectric plate 80 is a glass plate, the dielectric plate 10 may be a dielectric plate different from the glass plate. In the case where both of the pair of dielectric plates 10 and 80 are glass plates, the window glass 107 is also referred to as a laminated glass. Further, in the case where both of the pair of dielectric plates 10 and 80 are glass plates, they may be glass plates having the same composition or may be glass plates having different compositions.

In the case where the window glass 107 is a laminated glass, the thickness of the window glass 107, i.e., the total thickness of the pair of dielectric plates 10 and 80 and the intermediate film 90, may be 2.3 mm or larger and 6.0 mm or smaller. Further, the thickness of each of the pair of dielectric plates 10 and 80 included in the laminated glass may be 0.5 mm or larger and 3.5 mm or smaller. The thicknesses of the pair of dielectric plates 10 and 80 may be equal to each other or different from each other. Note that the thickness of the dielectric plate 10 which is positioned inside the vehicle when the window glass 107 is attached to the vehicle may be 0.5 mm or larger and 2.3 mm or smaller, preferably 0.8 mm or larger and 2.3 mm or smaller, and more preferably 1.0 mm or larger and 2.1 mm or smaller. When the thickness of the dielectric plate 10 is 0.5 mm or larger, the handling property becomes excellent, whereas when the thickness is 2.3 mm or smaller, the mass does not become too large. The thickness of the dielectric plate 80 which is positioned outside the vehicle when the window glass 107 is attached to the vehicle may be 1.0 mm or larger and 3.5 mm or smaller, preferably 1.0 mm or larger and 3.0 mm or smaller, and more preferably 1.1 mm or larger and 2.5 mm or smaller. When the thickness of the dielectric plate 80 is 1.0 mm or larger, the strength such as the tolerance to stone chips becomes sufficient, whereas when the thickness is 3.0 mm or smaller, the mass of the laminated glass does not become too large, which is preferable in view of the fuel consumption of the vehicle. When the thicknesses of the pair of dielectric plates 10 and 80 are both 2.1 mm or smaller, it is possible to achieve both the reduction in weight of the laminated glass and the sound insulation property, so it is preferable.

The dielectric plate 80 is, when the dielectric plate 10 is an example of the first dielectric plate, an example of the second dielectric plate opposed to the first dielectric plate. The dielectric plate 80 is disposed on the main surface 12 side with respect to the dielectric plate 10.

The dielectric plate 80 is a plate-like dielectric having a main surface 81 facing in the Z-axis negative direction and another main surface 82 facing in the direction opposite to the main surface 81 (i.e., in the Z-axis positive direction). Although the main surfaces 81 and 82 are shown parallel to the XY-plane in the drawing, the main surface 81 or 82 may be curved with respect to the XY-plane. In the case where the main surface 81 or 82 is curved with respect to the XY-plane, that is, the dielectric plate 80 has a curved shape, the dielectric plate 80 may have a single curved shape, i.e., curved in either the lateral direction or the vertical direction, or may have a double curved shape, i.e., curved in both the lateral direction and the vertical direction. In the case where the dielectric plate 80 has a curved shape, the radius of the curvature may be 2,000 to 11,000 mm. In the case where the dielectric plate 80 is a glass plate, gravity bending, press bending, roller bending, or the like is used for the bending of the dielectric plate 80.

In the case where the window glass 107 is a window glass for vehicle, the main surface 11 is a surface of the window glass 107 located inside the vehicle, and the main surface 82 is a surface of the window glass 107 located outside the vehicle. However, the main surface 11 may be a surface of the window glass 107 located outside the vehicle, and the main surface 82 may be a surface of the window glass 107 located inside the vehicle.

The intermediate film 90 is a transparent or semi-transparent dielectric disposed between the dielectric plates 10 and 80. The dielectric plates 10 and 80 are bonded to each other by the intermediate film 90. Examples of the intermediate film 90 include thermoplastic polyvinyl butyral (PVB), ethylene-vinyl acetate copolymer (EVA), and cycloolefin polymer (COP). Note that the relative permittivity of the intermediate film 90 is preferably 2.4 or higher and 3.5 or lower.

The receiving unit 30 and the electromagnetic band gap structure 50 are disposed between the dielectric plates 10 and 80. In the example shown in FIG. 8, the receiving unit 30 and the electromagnetic band gap structure 50 are disposed between the intermediate film 90 and the dielectric plate 10. However, at least one of the receiving unit 30 and the electromagnetic band gap structure 50 may be disposed between the intermediate film 90 and the dielectric plate 80, or may be disposed between two intermediate films 90. Further, in the case where there is an insulating layer 70 similar to the insulating layer in the above-described embodiments between the dielectric plates 10 and 80, at least one of the receiving unit 30 and the electromagnetic band gap structure 50 may be formed in the insulating layer 70.

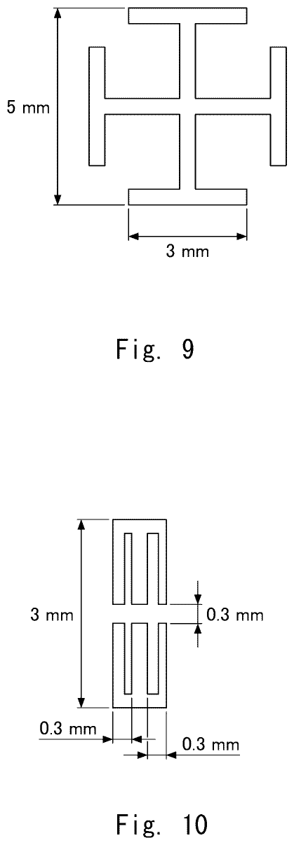

FIG. 9 is a plan view showing a first example of a unit cell included in an electromagnetic band gap structure. FIG. 10 is a plan view showing a second example of a unit cell included in an electromagnetic band gap structure. The shape of the unit cell is not limited to any particular shapes as long as a characteristic for suppressing the propagation of electromagnetic waves in a specific frequency band is obtained. The dimensions shown in FIGS. 9 and 10 are suitable values when the frequency of electromagnetic waves input to the feeding unit 20 is 28 GHz.

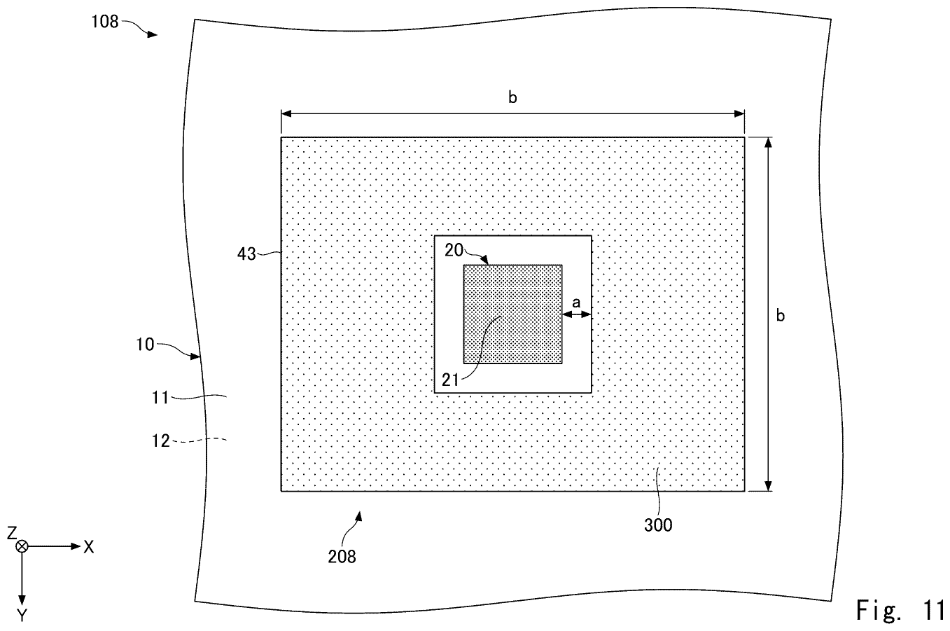

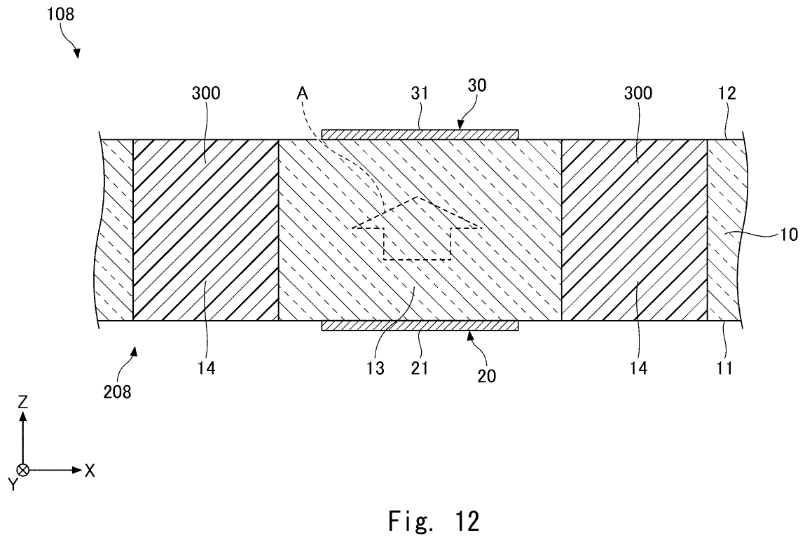

FIG. 11 is a partial plan view showing an example of a structure of a window glass including a feeding structure according to an eighth embodiment. FIG. 11 is a plan view of a window glass 108 (or a dielectric plate 10 included in the window glass 108). FIG. 12 is a partial cross-sectional view showing the example of the structure of the window glass including the feeding structure according to the eighth embodiment. The window glass 108 shown in FIGS. 11 and 12 is a plate-like article including a feeding structure 208 that feeds from a feeding unit 20 to a receiving unit 30 in a non-contact manner through electromagnetic coupling therebetween.

In the eighth embodiment, descriptions of structures, operations, and effects similar to those in the above-described embodiment will be omitted by referring to the descriptions in the above-described embodiment. The feeding structure 208 according to the eighth embodiment differs from the feeding structure 201 according to the first embodiment (FIG. 2) in that the dielectric region 14 is formed of a material having a relative permittivity different from that of the dielectric region 13.

In FIG. 12, the dielectric region 13 is a region mainly made of a first material having a relative permittivity ε₁ (i.e., the material of the dielectric plate 10), and the dielectric region 14 is a region mainly made of a second material having a relative permittivity 82 lower than the relative permittivity ε₁ (i.e., made of a dielectric 300). Since the relative permittivity ε₂ of the second material, which is the main component of the dielectric region 14, is lower than the relative permittivity ε₁ of the first material, which is the main component of the dielectric region 13, the leakage of the electromagnetic wave A from the dielectric region 13 to the dielectric region 14 is suppressed when the feeding unit 20 and the receiving unit 30 are electromagnetically coupled to each other. Further, the leakage of the electromagnetic wave A from the dielectric region 13 to the main surface 11 or 12 is suppressed. Therefore, since the loss of the electromagnetic wave A propagating from the feeding unit 20 to the receiving unit 30 through the dielectric region 13 is reduced, an effect of preventing the efficiency of the feeding from the feeding unit 20 to the receiving unit 30 from deteriorating is obtained.

The value of the relative permittivity ε₁ of the first material contained in the dielectric region 13 is, for example, 4 or higher and 10 or lower, and preferably 5 or higher and 9 or lower at a frequency of 3 GHz or higher. The value of the relative permittivity ε₂ of the second material contained in the dielectric region 14 is, for example, lower than the relative permittivity ε₁, and is 2 or higher and 5 or lower, and preferably 2.5 or higher and 4.5 or lower at a frequency of 3 GHz or higher. Specific examples of the first material include soda lime glass, borosilicate glass, and aluminosilicate glass. Specific examples of the second material include an acrylic resin, an ABS resin, a vinyl chloride resin, a silicon resin, and polycarbonate.

As shown in FIG. 11, the dielectric 300 (dielectric region 14) may be positioned so as to surround the feeding unit 20 in the plan view. For example, the dielectric 300 is disposed so as to surround the feeding electrode 21 in the plan view. By positioning the dielectric 300 (dielectric region 14) so as to surround the feeding unit 20 in the plan view, the dielectric region 13 is surrounded by the dielectric region 14, of which the relative permittivity is lower than that of the dielectric region 13, over the entire periphery. Therefore, the leakage of the electromagnetic wave A from the dielectric region 13 to the dielectric region 14 is suppressed over the entire periphery, so that the effect of preventing the efficiency of the feeding from the feeding unit 20 to the receiving unit 30 from deteriorating is enhanced.

In FIG. 11, the dielectric 300 (dielectric region 14) may be positioned inside a square region 43 of which the length b of each side is 3λ or longer and 5λ or shorter in the plan view. In this way, similarly to the first embodiment, the effect of preventing the efficiency of the feeding from the feeding unit 20 to the receiving unit 30 from deteriorating is ensured, and the expansion of the range in which the dielectric 300 is disposed is prevented.

The length a of the gap between the inner edge of the dielectric 300 and the feeding electrode 21 of the feeding unit 20 may be 0.1λ or longer and 0.5λ or shorter in the plan view. In this way, similarly to the first embodiment, the deterioration of the effect of blocking electromagnetic waves caused by the interference between the inner edge of the dielectric 300 and the feeding electrode 21 of the feeding unit 20 is prevented, and the leakage of electromagnetic waves from the area between the inner edge of the dielectric 300 and the feeding electrode 21 of the feeding unit 20 is suppressed.

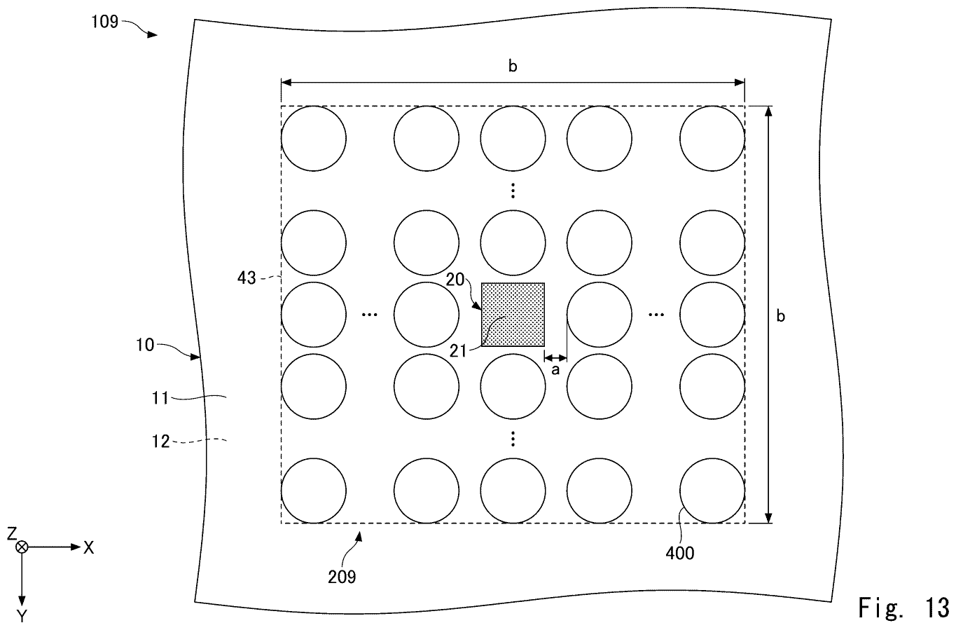

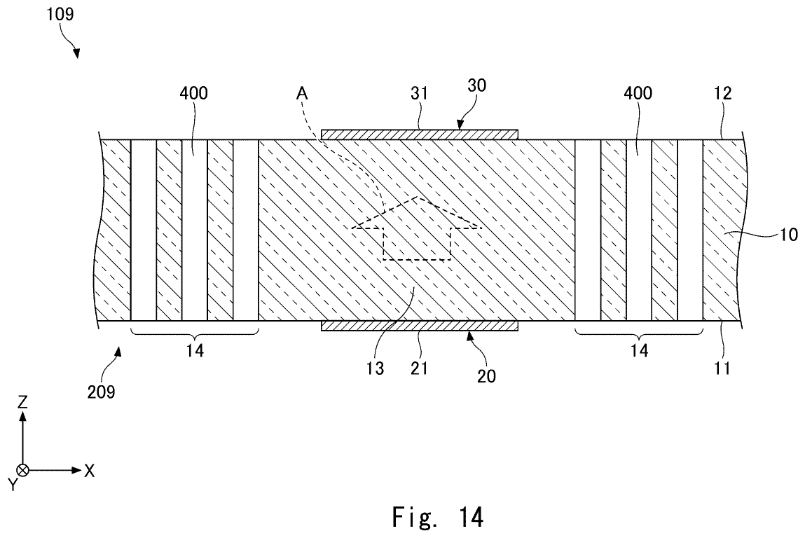

FIG. 13 is a partial cross-sectional view showing an example of a structure of a window glass including a feeding structure according to a ninth embodiment. FIG. 13 is a plan view of a window glass 109 (or a dielectric plate 10 included in the window glass 109). FIG. 14 is a partial cross-sectional view showing the example of the structure of the window glass including the feeding structure according to the ninth embodiment. The window glass 109 shown in FIGS. 13 and 14 is a plate-like article including a feeding structure 209 that feeds from a feeding unit 20 to a receiving unit 30 in a non-contact manner through electromagnetic coupling therebetween.

In the ninth embodiment, descriptions of structures, operations, and effects similar to those in the above-described embodiment will be omitted by referring to the descriptions in the above-described embodiment. The feeding structure 209 according to the ninth embodiment differs from the feeding structure 201 according to the first embodiment (FIG. 2) in that the dielectric region 14 includes a plurality of through-holes 400 penetrating the dielectric plate 10 in the thickness direction of the dielectric plate 10.

In FIG. 14, since the dielectric region 14 includes the plurality of through-holes 400 penetrating the dielectric plate 10 in the thickness direction of the dielectric plate 10, the dielectric region 14 has an effective relative permittivity lower than that of the dielectric region 13. As a result, the leakage of the electromagnetic wave A from the dielectric region 13 to the dielectric region 14 is suppressed when the feeding unit 20 and the receiving unit 30 are electromagnetically coupled to each other. Further, the leakage of the electromagnetic wave A from the dielectric region 13 to the main surface 11 or 12 is suppressed. Therefore, since the loss of the electromagnetic wave A propagating from the feeding unit 20 to the receiving unit 30 through the dielectric region 13 is reduced, an effect of preventing the efficiency of the feeding from the feeding unit 20 to the receiving unit 30 from deteriorating is obtained.

The value of the effective relative permittivity of the dielectric region 14 is lower than the relative permittivity ε₁ of the dielectric region 13, and may be roughly equal to the above-described relative permittivity ε₂.

As shown in FIG. 13, a plurality of through-holes 400 (dielectric region 14) may be positioned so as to surround the feeding unit 20 in the plan view. For example, a plurality of through-holes 400 are arranged so as to surround the feeding electrode 21 in the plan view. Since the plurality of through-holes 400 (dielectric region 14) are positioned so as to surround the feeding unit 20 in the plan view, the dielectric region 13 is surrounded by the dielectric region 14 having an effective relative permittivity lower than that of the dielectric region 13 over the entire periphery. Therefore, the leakage of the electromagnetic wave A from the dielectric region 13 to the dielectric region 14 is suppressed over the entire periphery, so that the effect of preventing the efficiency of the feeding from the feeding unit 20 to the receiving unit 30 from deteriorating is enhanced.

In FIG. 13, the plurality of through-holes 400 (dielectric region 14) may be positioned inside a square region 43 of which the length b of each side is 3λ or longer and 5λ or shorter in the plan view. In this way, similarly to the first embodiment, the effect of preventing the efficiency of the feeding from the feeding unit 20 to the receiving unit 30 from deteriorating is ensured, and the expansion of the range in which the plurality of through-holes 400 are arranged is prevented.

The length a of the gap between the innermost through-hole among the plurality of through-holes 400 and the feeding electrode 21 of the feeding unit 20 may be 0.1λ or longer and 0.5λ or shorter in the plan view. In this way, similarly to the first embodiment, the deterioration of the effect of blocking electromagnetic waves caused by the interference between the innermost through-hole among the plurality of through-holes 400 and the feeding electrode 21 of the feeding unit 20 is prevented, and the leakage of electromagnetic waves from the area between the innermost through-hole among the plurality of through-holes 400 and the feeding electrode 21 of the feeding unit 20 is suppressed.

Although embodiments have been described above, the above-described embodiments are shown merely as examples, and the present invention is not limited by the above-described embodiments. The above-described embodiments can be carried out in various other forms, and various combinations, omissions, replacements, and modifications can be made without departing from the scope and spirit of the invention. These embodiments and modifications thereof are included in the scope and spirit of the invention, and are included in the scope equivalent to the scope of the invention specified in the claims.

For example, the plate-like article in the embodiments is not limited to window glasses, and may be other plate-like articles or the like such as a display panel. Further, the plate-like article and the window glass in the embodiments are not limited to those for vehicles, and may be used for other purposes such as for buildings or electronic apparatuses. Examples of electronic apparatuses include portable apparatuses such as smartphones, cellular phones, and tablet-type computers.

What is claimed is:

1. A feeding structure comprising:
a dielectric plate for vehicle window having a first surface and a second surface opposite to the first surface;
a feeding unit positioned on the first surface side of the dielectric plate; and
a receiving unit positioned on the second surface side of the dielectric plate, wherein
the dielectric plate includes a first dielectric region between the feeding unit and the receiving unit, and a second dielectric region adjacent to the first dielectric region in a plan view, and
the second dielectric region has a relative permittivity lower than that of the first dielectric region when the feeding unit and the receiving unit are electromagnetically coupled to each other.

2. The feeding structure according to claim 1, further comprising an electromagnetic band gap structure positioned on the first surface side or the second surface side of the dielectric plate, wherein
the electromagnetic band gap structure includes a part overlapping the second dielectric region in the plan view.

3. The feeding structure according to claim 2, the electromagnetic band gap structure is positioned so as to surround the feeding unit or the receiving unit in the plan view.

4. The feeding structure according to claim 3, wherein when a wavelength, in the atmosphere, of an electromagnetic wave input to the feeding unit is represented by λ, the electromagnetic band gap structure is positioned inside a square region of which a length of each side is 3λ or longer and 5λ or shorter in the plan view.

5. The feeding structure according to claim 2, wherein when a wavelength, in the atmosphere, of an electromagnetic wave input to the feeding unit is represented by λ, a length of a gap between the electromagnetic band gap structure and the feeding unit or the receiving unit is 0.1λ or longer and 0.5λ or shorter in the plan view.

6. The feeding structure according to claim 2, wherein the electromagnetic band gap structure is positioned on a surface on which the feeding unit or the receiving unit is also disposed.

7. The feeding structure according to claim 2, wherein the electromagnetic band gap structure is positioned in an insulating layer in which the feeding unit or the receiving unit is also disposed.

8. The feeding structure according to claim 2, wherein the electromagnetic band gap structure has a periodic structure in which a plurality of unit cells are arranged in a periodic manner.

9. The feeding structure according to claim 2, further comprising a first insulating layer positioned on the first surface side of the dielectric plate, and
the electromagnetic band gap structure is formed in the first insulating layer.

10. The feeding structure according to claim 9, wherein
the first insulating layer has a third surface opposed to the first surface and a fourth surface opposite to the third surface, and
the electromagnetic band gap structure is formed on the third surface or the fourth surface.

11. The feeding structure according to claim 10, wherein the feeding unit is formed on the third surface or the fourth surface.

12. The feeding structure according to claim 11, wherein the electromagnetic band gap structure is formed on a surface on which the feeding unit is also formed.

13. The feeding structure according to claim 2, further comprising a second insulating layer positioned on the second surface side of the dielectric plate, and
the electromagnetic band gap structure is formed in the second insulating layer.

14. The feeding structure according to claim 13, wherein
the second insulating layer has a fifth surface opposed to the second surface and a sixth surface opposite to the fifth surface, and
the electromagnetic band gap structure is formed on the fifth surface or the sixth surface.

15. The feeding structure according to claim 14, wherein the receiving unit is formed on the fifth surface or the sixth surface.

16. The feeding structure according to claim 15, wherein the electromagnetic band gap structure is formed on a surface on which the receiving unit is also formed.

17. The feeding structure according to claim 1, wherein the second dielectric region is formed of a material having a relative permittivity different from that of the first dielectric region.

18. The feeding structure according to claim 1, wherein the second dielectric region includes a plurality of through-holes formed in the dielectric plate in a thickness direction of the dielectric plate.

19. A window glass comprising a feeding structure according to claim 1.

20. The window glass according to claim 19, further comprising a second dielectric plate opposed to the dielectric plate, and
the receiving unit is located between the dielectric plate and the second dielectric plate.
